(19) United States
(12) Patent Application Publication
(10) Pub. No.: US 2025/0227065 A1
(43) Pub. Date: Jul. 10, 2025

(54) METHODS, APPARATUS, AND ARTICLES OF MANUFACTURE TO CONFIGURE CONTENT-ADDRESSABLE MEMORY RESOURCES

(71) Applicant: Intel Corporation, Santa Clara, CA (US)

(72) Inventors: Andrey Chilikin, Limerick (IE); Qi Zhang, Shanghai (CN)

(73) Assignee: Intel Corporation, Santa Clara, CA (US)

(21) Appl. No.: 19/094,373

(22) Filed: Mar. 28, 2025

(30) Foreign Application Priority Data
Feb. 25, 2025 (WO) PCT/CN2025/078919

(51) Int. Cl. H04L 45/745; H04L 41/0816; H04L 45/655

(52) U.S. Cl. CPC H04L 45/74591; H04L 41/0816; H04L 45/655

(57) ABSTRACT

Systems, apparatus, articles of manufacture, and methods are disclosed to configure content-addressable memory resources. An example apparatus includes interface circuitry to access parameters to be used to configure content-addressable memory (CAM) of a compute device to implement a packet flow table, machine-readable instructions, and at least one programmable circuit to be programmed by the machine-readable instructions. The at least one programmable circuit is to convert the parameters into a hardware representation of the packet flow table, generate, based on the hardware representation, candidate configurations of two or more CAM slices of the compute device that satisfy the parameters, select one of the candidate configurations of the two or more CAM slices to implement the packet flow table based on respective performance characteristics of the candidate configurations, and configure the two or more CAM slices based on the selected one of the candidate configurations.

### RELATED APPLICATIONS

This patent claims the benefit of International Application No. PCT/CN2025/078919, which was filed on Feb. 25, 2025. International Application No. PCT/CN2025/078919 is hereby incorporated herein by reference in its entirety. Priority to International Application No. PCT/CN2025/078919 is hereby claimed.

### BACKGROUND

Content-addressable memory (CAM) is a type of computer memory used in very-high-speed searching applications. CAM is also known as associative memory or associative storage. In operation, CAM compares search data against a table of stored data and returns the address of matching data. CAM is used in networking devices where the CAM speeds up forwarding table and routing table operations. CAM, also referred to as associative memory, is also used in cache. In associative cache, both address and content are stored side by side (e.g., contiguously). When an address in the associative cache matches input search data, content corresponding to the address is fetched from the associative cache.

### BRIEF DESCRIPTION OF THE DRAWINGS

FIG. 1 is a block diagram of an example system including example programmable circuitry in communication with an example network via an example network device.

FIG. 2 is a block diagram illustrating example configurations of four ternary content-addressable memory (TCAM) slices.

FIG. 3 is a block diagram of an example implementation of the memory configuration control circuitry of FIG. 1.

FIG. 4 is a flowchart representative of example machine-readable instructions and/or example operations that may be executed, instantiated, and/or performed by example programmable circuitry to implement the memory configuration control circuitry of FIGS. 1 and/or 3.

FIG. 5 is a block diagram of example hardware representations of flow tables to be programmed onto one or more TCAM slices.

FIG. 6 is a block diagram illustrating example candidate configurations of TCAM slices, example mappings of example hardware representations to each of the candidate configurations, and example verification of the mappings.

FIG. 7 is a block diagram of example candidate configurations having different score vectors.

FIG. 8 is a flowchart representative of example machine-readable instructions and/or example operations that may be executed, instantiated, and/or performed by example programmable circuitry to implement the memory configuration control circuitry of FIGS. 1 and/or 3 to convert parameters for two or more flow tables into two or more hardware representations of the two or more flow tables.

FIG. 9A is a flowchart representative of example machine-readable instructions and/or example operations that may be executed, instantiated, and/or performed by example programmable circuitry to implement the memory configuration control circuitry of FIGS. 1 and/or 3 to condense a search space for configurations of two more CAM slices.

FIG. 9B is a flowchart representative of example machine-readable instructions and/or example operations that may be executed, instantiated, and/or performed by example programmable circuitry to implement the memory configuration control circuitry of FIGS. 1 and/or 3 to condense a search space for configurations of two more CAM slices.

FIG. 10 is a graphical illustration depicting how grouping example candidate configurations of two or more CAM slices and example hardware representations by shape reduces the computational burden of performing CAM configuration search.

FIG. 11 is a block diagram of an example processing platform including programmable circuitry structured to execute, instantiate, and/or perform the example machine-readable instructions and/or perform the example operations of FIGS. 4, 8, 9A, and 9B to implement the memory configuration control circuitry of FIG. 3.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 4, 8, 9A, and 9B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

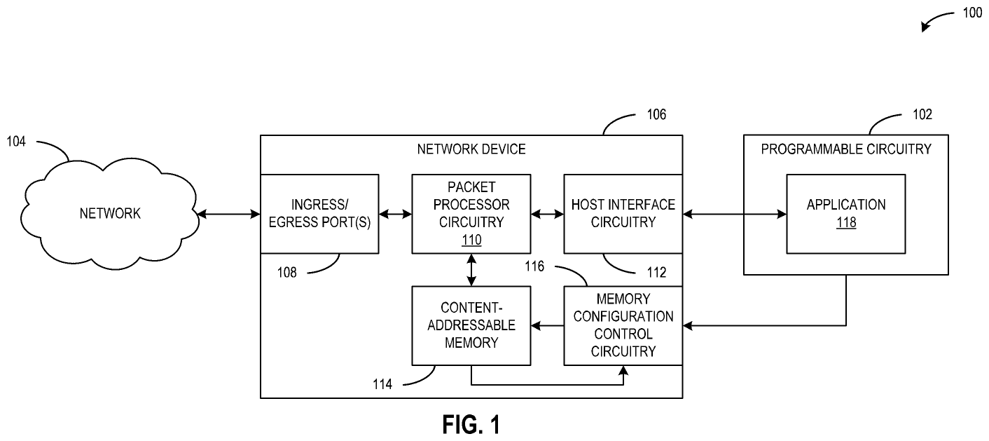

CAM is often used in computer networking devices such as network controllers network routers, and network switches. Other CAM applications include fully associative cache controllers, translation lookaside buffers, database engines, data compression hardware, artificial neural networks (NNs), intrusion prevention systems, network processors, and special-purpose computers, for example, designed around associative memory. FIG. 1 is a block diagram of an example system 100 including example programmable circuitry 102 in communication with an example network 104 via an example network device 106.

In the illustrated example of FIG. 1, the system 100 is a compute device such as a personal computer, a server, a mobile phone, a tablet computer, and/or any other compute device. In the example of FIG. 1, the programmable circuitry 102 is a host processor of the system 100. For example, the programmable circuitry 102 is implemented by one or more central processor units (CPUs).

In the illustrated example of FIG. 1, the network 104 represents the Internet. Additionally or alternatively, the network 104 may be implemented using any suitable wired and/or wireless network(s) including, for example, one or more data buses, one or more Local Area Networks (LANs), one or more wireless LANs, one or more cellular networks, one or more private networks, one or more public networks, etc. In the example of FIG. 1, the network 104 facilitates communication between the system 100 and other compute devices.

In the illustrated example of FIG. 1, the network device 106 is interface circuitry facilitating communication between the programmable circuitry 102 and the network 104. For example, the network device 106 is implemented by one or more of network interface circuitry (NIC), an infrastructure processing unit (IPU), a data processing unit (DPU), and/or any other interface circuitry. In the example of FIG. 1, the network device 106 includes example ports 108, example packet processor circuitry 110, example host interface circuitry 112, example content-addressable memory (CAM) 114, and example memory configuration control circuitry 116.

In the illustrated example of FIG. 1, the ports 108 are coupled to the network 104. In the example of FIG. 1, the ports 108 represent ingress ports and egress ports of the network device 106. In examples disclosed herein, an ingress port refers to a port of the network device 106 at which data enters the system 100. For example, data entering an ingress port of the network device 106 may be addressed to an example application 118 executed and/or instantiated by the programmable circuitry 102.

In examples disclosed herein, an egress port refers to a port of the network device 106 where data exits the system 100. For example data leaving an egress port of the network device 106 may have originated from the application 118. In some examples, the same port may be referred to as an ingress port and an egress port. For example, at a first instance of time, a port receives data from the network 104 (e.g., acting as an ingress port) and at a second instance of time, the port provides data to the network 104 (e.g., acting as an egress port).

In the illustrated example of FIG. 1, the packet processor circuitry 110 is coupled to the ports 108, the host interface circuitry 112, and the CAM 114. In the example of FIG. 1, the packet processor circuitry 110 is implemented by programmable circuitry as described herein. For example, the packet processor circuitry 110 is implemented by a CPU, a field programmable gate array (FPGA), a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc.

In the illustrated example of FIG. 1, the packet processor circuitry 110 parses packets of data passing through the network device 106. For example, the packet processor circuitry 110 examines ingress traffic from the network 104 to determine where to route the ingress traffic (e.g., to the application 118 via the host interface circuitry 112, to another application, to other programmable circuitry, etc.). Additionally, the packet processor circuitry 110 examines egress traffic from the programmable circuitry 102 (e.g., generated by the application 118, generated by another application, etc.) to determine where to route the egress traffic in the network 104.

In the illustrated example of FIG. 1, when the network device 106 receives a data frame at an ingress port of the network device 106, the packet processor circuitry 110 examines ingress traffic to generate context based on attributes of data included in packets of the ingress traffic. For example, the packet processor circuitry 110 updates an internal table with the source media access control (MAC) address of the data frame and the ingress port at which the data frame was received. In the example of FIG. 1, the packet processor circuitry 110 also identifies destinations for packets passing through the network device 106.

For example, the packet processor circuitry 110 looks up a destination MAC address in the internal table to determine an egress port to which the data frame is to be forwarded and sends the data frame out on the egress port. In the example of FIG. 1, the internal table can be implemented as an access control list (ACL) and/or one or more classification filters. For example, the packet processor circuitry 110 accesses an access control list (ACL) to determine a destination for a packet. Additionally or alternatively, the packet processor circuitry 110 applies one or more classification filters to packets passing through the network device 106.

Example classification filters include flow-level classification filters. A flow-level classification filter allows the packet processor circuitry 110 to classify packets as corresponding to a packet flow. Additional or alternative classification filters include receive side scaling (RSS) filters that allow the packet processor circuitry 110 to classify packets based on a hash function of fields in a packet header. In the example of FIG. 1, a packet flow refers to a sequence of packets from a source device to a destination device. For example, a packet flow may be a sequence of packets corresponding to streaming media. Other examples of packet flows include sequences of packets corresponding to web browsing, voice over internet protocol (IP) (VOIP) calls, file transfers, online gaming, email communication, and domain name server (DNS) queries, among other applications.

In the illustrated example of FIG. 1, the internal table of the network device 106 can be implemented by the CAM 114 so that a destination and/or egress port for ingress traffic can be found quickly, reducing latency of the network device 106. In the example of FIG. 1, the packet processor circuitry 110 accesses the CAM 114 to perform routing of packets. For example, the CAM 114 stores one or more ACLs, one or more classification filters, and/or one or more flow tables.

In the illustrated example of FIG. 1, a flow table (used interchangeably with packet flow table) refers to a data structure within the CAM 114 that stores information about one or more packet flows. For example, the flow table describes an address space on one or more slices of the CAM 114 and the information about one or more packet flows is stored in the address space. In the example of FIG. 1, information stored in a flow table includes one or more rules specifying how a packet flow is to be routed. Based on receiving a packet, the packet processor circuitry 110 accesses the CAM 114 to identify a particular packet flow and thus a flow table to which a packet corresponds. In the example of FIG. 1, the packet processor circuitry 110 routes the packet according to the information stored in the flow table. In some examples, two or more flow tables can be cascaded to that network traffic can be incrementally filtered.

In the illustrated example of FIG. 1, the host interface circuitry 112 is coupled to the packet processor circuitry 110 and the programmable circuitry 102. In the example of FIG. 1, the host interface circuitry 112 is implemented by programmable circuitry as described herein. In the example of FIG. 1, the host interface circuitry 112 facilitates communication between the network device 106 and the programmable circuitry 102 according to an interface standard.

Example interface standards include a Peripheral Component Interconnect (PCI) interface, a PCI Express (PCIe) interface, and/or a Compute Express Link (CXL) interface. Example CXL interfaces include the CXL interface for cache-coherent accesses to system memory (CXL.cache or CXL.$), the CXL interface for device memory (CXL.Mem), and the CXL interface for PCIe-based I/O devices (CXL.IO/PCIe). Additionally or alternatively, the host interface circuitry 112 facilitates communication according to an Ethernet interface, a universal serial bus (USB) interface, a Bluetooth® interface, and/or a near field communication (NFC) interface. In some examples, the host interface circuitry 112 facilitates communication according to a die-to-die interconnect such as an embedded multi-die interconnect bridge (EMIB), a co-EMIB, a high bandwidth memory (HBM) interconnect, a chip-on-wafer-on-substrate (CoWoS) interconnect, an integrated fan-out (InFO) interconnect, and/or an organic substrate-based interconnect.

In the illustrated example of FIG. 1, the CAM 114 is coupled to the packet processor circuitry 110 and the memory configuration control circuitry 116. In principle, CAM operates by processing a data word and returning a list of one or more storage addresses at which the data word is found. For example, based on a data word (e.g., supplied by the packet processor circuitry 110), CAM searches the entire memory capacity of the CAM to determine if the data word is stored anywhere in the CAM. If the CAM finds the data word, the CAM returns a list of one or more storage addresses at which the data word is found.

The example CAM 114 of FIG. 1 may be implemented by binary CAM (BCAM) or ternary CAM (TCAM). BCAM processes data comprised of bits having values consisting of 1s and 0s (e.g., a true state or a false state, respectively). TCAM allows for the bits of data to have a third state, X (e.g., a do not care state), which provides more flexibility for data search words. For example, a stored word having a binary value of 10XX0 in TCAM will match any of the data search words 10000, 10010, 10100, or 10110. To facilitate the third state, TCAM can add a mask bit (e.g., in a care or a do not care state) to every memory cell of the TCAM. In the example of FIG. 1, the CAM 114 is implemented by TCAM.

TCAM is a useful resource in network controllers, routers, and switches, distinguished by the high-speed packet matching that can be performed by TCAM, including wildcard matching capabilities. CAM (e.g., BCAM, TCAM, etc.), can be implemented by one or more memory slices also referred to as CAM slices. For example, if CAM has a memory capacity of C (measured in bits, bytes (B), kilobytes (KB), megabytes (MB), gigabytes (GB), etc.), then the CAM can be divided into one or more memory slices where each memory slice corresponds to a portion of the capacity C (e.g., each memory slice having a capacity less than or equal to C).

To cater to the diverse demands of different use cases, hardware vendors provide a range of differently sized TCAM slices and the flexibility to stack TCAM slices horizontally or vertically, allowing for the composition of distinct match tables. Stacking TCAM slices horizontally refers to combining two or more TCAM slices along the x-axis of a TCAM (e.g., horizontally) to create a composite TCAM slice that is represented by the two or more TCAM slices. As such, the width of a composite TCAM slice comprised of two or more horizontally stacked TCAM slices is greater than the width of any of the component TCAM slices.

Stacking TCAM slices vertically refers to combining two or more TCAM slices along the y-axis of a TCAM (e.g., vertically) to create a composite TCAM slice that is represented by the two or more TCAM slices. As such, the height of a composite TCAM slice comprised of two or more vertically stacked TCAM slices is greater than the height of any of the component TCAM slices. The flexibility to stack TCAM slices empowers network administrators with customization options but also introduces a large number of candidate TCAM configurations.

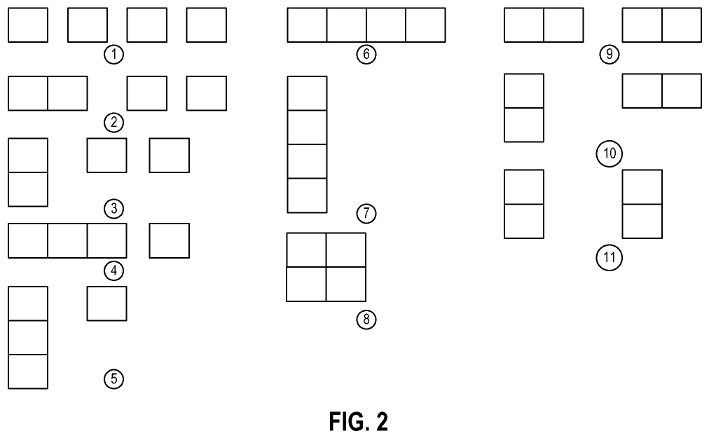

In practice, identifying the most efficient TCAM configuration among candidate TCAM configurations is increasingly impractical due to the complexity of analysis required to search through the large number of candidate TCAM configurations. For example, FIG. 2 is a block diagram illustrating example configurations of four TCAM slices. As illustrated in FIG. 2, there are eleven candidate TCAM configurations to explore for four TCAM slices. As the number of TCAM slices available in a hardware platform increases, the complexity to identify the most efficient TCAM configuration among candidate TCAM configurations increases exponentially.

For example, there are 94 candidate TCAM configurations to explore for eight TCAM slices and 3,186 candidate TCAM configurations to explore for 16 TCAM slices. For 32 TCAM slices, there are 848,209 candidate TCAM configurations to explore. Additionally, any number of TCAM slices can be architected in a way that increases the number of candidate TCAM configurations. For example, with 16 TCAM slices grouped in two sets of eight TCAM slices that are configured in a pipeline, there are 8,836 candidate TCAM configurations to explore.

The exponential growth in complexity makes the search through candidate TCAM configurations untenable, especially in large-scale network environments. For example, manually searching through candidate TCAM configurations would consume an excessive amount of computing time and computational effort while lacking the precision to optimize TCAM utilization effectively. Furthermore, performing candidate TCAM configuration searching manually and/or via brute force analysis may limit the applications in which a hardware vendor can support a range of TCAM slices. For example, performing candidate TCAM configuration searching manually and/or via brute force analysis may limit a hardware vendor to supporting TCAM configuration in IP version 4 (IPv4) and IP version 6 (IPv6) applications.

Addressing the challenge of TCAM configuration can improve (e.g., optimize) network device performance, reduce operational costs in a network, and ensure scalability of a network. Advantageously, the network device 106 includes the memory configuration control circuitry 116 to analyze user-defined parameters for flow tables (e.g., packet types, key fields (e.g., for matching), rule numbers (e.g., rule counts), and priority levels) to generate a highly efficient configuration for the CAM 114. For example, the memory configuration control circuitry 116 facilitates resource usage efficiency and enhanced network performance while overcoming the impracticality of TCAM configuration searching.

In the illustrated example of FIG. 1, the memory configuration control circuitry 116 is coupled to the CAM 114 and the programmable circuitry 102. In the example of FIG. 1, the memory configuration control circuitry 116 is implemented by programmable circuitry as described herein. For example, the memory configuration control circuitry 116 is implemented by a CPU, an FPGA, a PLD, a GAL device, a PAL device, a CPLD, a SPLD, a MCU, a PSoC, etc.

In the illustrated example of FIG. 1, the memory configuration control circuitry 116 generates a configuration for the CAM 114. In the example of FIG. 1, the memory configuration control circuitry 116 accesses parameters for two or more flow tables to be stored in the CAM 114. For example, the memory configuration control circuitry 116 accesses the parameters from the programmable circuitry 102 (e.g., based on user input to an application such as the application 118). Example parameters for a flow table include packet type, key field, priority, and minimum rule number.

In the illustrated example of FIG. 1, a packet type parameter refers to a type of packet to be detected in network traffic for a flow table. In the example of FIG. 1, a key field parameter refers to a field in a packet that is used to classify (or key) a packet into a particular packet flow. Also, a priority parameter refers to a priority according to which a flow table is to take precedence when a packet matches multiple flow tables. In the example of FIG. 1, the minimum rule number parameter refers to a minimum number of rules to be stored in a flow table. In other words, the minimum rule number parameter refers to a lower threshold for a rule count of a flow table.

In the illustrated example of FIG. 1, the memory configuration control circuitry 116 normalizes the parameters as described herein. For example, normalization includes the memory configuration control circuitry 116 converting the parameters for the two or more flow tables into two or more hardware representations of the two or more flow tables. In examples disclosed herein, a hardware representation of a flow table describes the layout of a flow table on hardware (e.g., the CAM 114) based on packet type, key field, priority, and table size (e.g., determined by the size of the key field and the minimum rule number).

For example, the hardware representation of a flow table (also referred to as a structured hardware representation, a profile table, or a hardware flow table) is an abstract representation of the flow table that represents how information stored in the flow table is implemented on specific hardware (e.g., the CAM 114). In the example of FIG. 1, the memory configuration control circuitry 116 programs hardware flow tables onto the CAM 114 during initialization of the CAM 114. After initialization of the CAM 114, a hardware representation of a flow table is utilized during runtime to perform rule programming and/or rule matching.

To perform rule matching, a hardware representation of a flow table uses the packet type of a packet to look up a key field for the packet, a starting slice of the CAM 114 at which the hardware representation of the flow table starts, an entry offset of the starting slice of the CAM 114, and stacking information for the hardware representation of the flow table. In examples disclosed herein, stacking information describes the number and arrangement of slices of the CAM 114 that are stacked horizontally and/or vertically to form a region of the CAM 114 that stores a flow table. Based on information returned from the CAM 114, the packet processor circuitry 110 processes the packet and forwards the packet to a destination address.

As described herein, the memory configuration control circuitry 116 resolves priority of flow tables to ensure that higher priority flow tables take precedence over lower priority flow tables if the information of two flow tables share the same slice of the CAM 114. As such, when the packet processor circuitry 110 queries the CAM 114 with a packet, the CAM 114 may not provide a priority parameter as an output. In additional or alternative examples, the CAM 114 provides a priority parameter as an output when queried.

In the illustrated example of FIG. 1, the memory configuration control circuitry 116 explores candidate configurations for the CAM 114 based on the normalized parameters. Additionally, based on scores for the candidate configurations, the memory configuration control circuitry 116 selects one of the candidate configurations for the CAM 114 that satisfies the normalized parameters. Using the selected configuration for the CAM 114, the memory configuration control circuitry 116 programs and/or otherwise configures the CAM 114 to store the two or more flow tables.

As such, examples disclosed herein streamline and optimize CAM resource utilization. For example, by avoiding a trial-and-error process and intelligently selecting an appropriate TCAM configuration, examples disclosed herein improve (e.g., revolutionize) TCAM resource management. As such, examples disclosed herein make TCAM configuration more efficient, cost-effective, and adaptable to the demands of modern networking environments. Thus, examples disclosed herein mitigate the challenges associated with TCAM configuration within network controllers, routers, and switches.

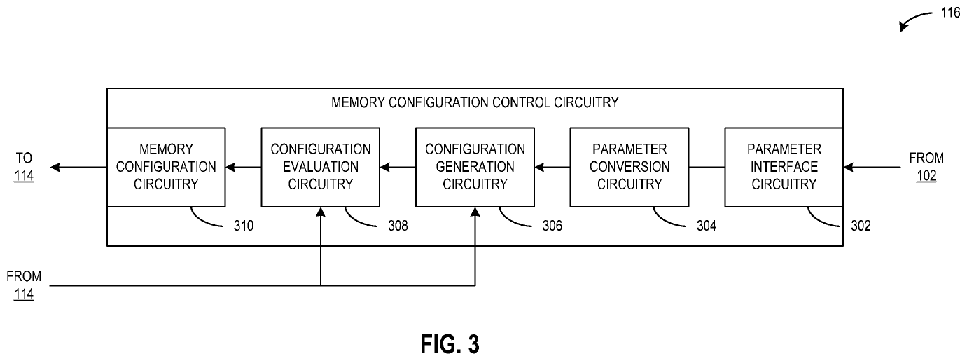

FIG. 3 is a block diagram of an example implementation of the memory configuration control circuitry 116 of FIG. 1. In the example of FIG. 3, the memory configuration control circuitry 116 includes example parameter interface circuitry 302, example parameter conversion circuitry 304, example configuration generation circuitry 306, example configuration evaluation circuitry 308, and example memory configuration circuitry 310. The memory configuration control circuitry 116 of FIG. 3 may be instantiated (e.g., creating an instance of, bring into being for any length of time, materialize, implement, etc.) by programmable circuitry.

For example, programmable circuitry may be implemented by a CPU executing first instructions, an FPGA, a PLD, a GAL device, a PAL device, a CPLD, a SPLD, a MCU, a PSoC, etc. Additionally or alternatively, the memory configuration control circuitry 116 of FIG. 3 may be instantiated (e.g., creating an instance of, bring into being for any length of time, materialize, implement, etc.) by (i) an Application Specific Integrated Circuit (ASIC) and/or (ii) an FPGA (e.g., another form of programmable circuitry) structured and/or configured in response to execution of second instructions to perform operations corresponding to the first instructions.

It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the illustrated example of FIG. 3, the parameter interface circuitry 302 is coupled to the programmable circuitry 102 and the parameter conversion circuitry 304. In the example of FIG. 3, the parameter interface circuitry 302 accesses parameters (e.g., is to access parameters) for flow tables from the programmable circuitry 102. For example, a user (e.g., a network administrator) can define the parameters for the flow tables via the programmable circuitry 102. As described above, example parameters for a flow table include packet type, key field, priority, and minimum rule number. An example packet type parameter refers to a type of packet to be detected in network traffic for a flow table.

In examples disclosed herein, a key field parameter refers to a field in a packet that is used to classify (or key) a packet into a particular packet flow. Example key fields include a source port field, a destination port field, a source MAC address field, and a destination MAC address field, an EtherType field, a virtual local area network (VLAN) identifier (ID) field, a virtual extensible local area network (VXLAN) ID field, a priority code point (PCP) field, a source IP address field, and a destination IP address field. Example key fields additionally or alternatively include an IP protocol field (e.g., identifying a higher layer protocol such as transmission control protocol (TCP) or user datagram protocol (UDP) that is encapsulated within an IP packet), an IP type of service (ToS) field, a TCP/UDP source port field, and a TCP/UDP destination port field.

In example described herein, a key field parameter can be identified via a protocol offset. For example, a protocol offset refers to a number of bits in a packet (e.g., a packet including a header and a payload) that precedes a key field identified by the protocol offset. In examples disclosed herein, a priority parameter refers to a priority according to which a flow table is to take precedence when a packet matches multiple flow tables. An example minimum rule number parameter refers to a minimum number of rules to be stored in a flow table.

In the illustrated example of FIG. 3, the parameter conversion circuitry 304 is coupled to the parameter interface circuitry 302 and the configuration generation circuitry 306. In the example of FIG. 3, the parameter conversion circuitry 304 normalizes parameters for flow tables regardless of the format in which a user provides the parameters. For example, the parameter conversion circuitry 304 interprets user-defined network parameters received in various manners, such as in a domain specific language (DSL) (e.g., the programming protocol-independent packet processors (P4) language), via a flow filter application programming interface (API) (e.g., a data plane development kit (DPDK) flow filter), or in a natural language string. That is, in the example of FIG. 3, the parameter conversion circuitry 304 adapts to different user parameter input types.

For example, if a user provides parameters via a flow filter API (e.g., a DPDK flow filter), the parameter conversion circuitry 304 implements a parsing scripter to translate the parameters into a structured hardware representation of a flow table. Additionally, for example, if a user provides parameters in a DSL (e.g., P4), the parameter conversion circuitry 304 implements a compiler to translate the parameters into a structured hardware representation of a flow table. That is, based on code representative of the parameters, the parameter conversion circuitry 304 compiles the code to generate the structured hardware representation of the flow table. If a user provides parameters as a natural language input (e.g., a natural language representation), the parameter conversion circuitry 304 implements an artificial intelligence (AI) model (e.g., a large language model (LLM), an NN, etc.) to translate the parameters into a structured hardware representation of a flow table. By supporting natural language inputs, the parameter conversion circuitry 304 allows users to express network parameters in plain language.

In the illustrated example of FIG. 3, regardless of the input format in which parameters are provided to the memory configuration control circuitry 116, the parameter conversion circuitry 304 translates the parameters into a structured hardware representation of a flow table. For example, for each group of parameters, the parameter conversion circuitry 304 normalizes the group of parameters into a structured hardware representation of a flow table to be programmed onto one or more slices of the CAM 114. As such, the parameter conversion circuitry 304 provides one or more structured hardware representations of one or more flow tables that are specific to the hardware of a vendor of the CAM 114.

As described herein, a structured hardware representation of a flow table describes the layout of the flow table on hardware (e.g., the CAM 114). For example, a structured hardware representation is a matrix that includes a width defined by the size (e.g., length) of the key field parameter and a minimum height defined by the minimum rule number parameter. Additionally, for example, the matrix (e.g., the structured hardware representation) includes information a packet type of packets to be processed according to a flow table, a key field of packets to be utilized to match the packets to one or more rules of the flow table, the one or more rules, a starting slice of the CAM 114 at which the structured hardware representation of the flow table starts, an entry offset of the starting slice of the CAM 114, and stacking information for the structured hardware representation of the flow table.

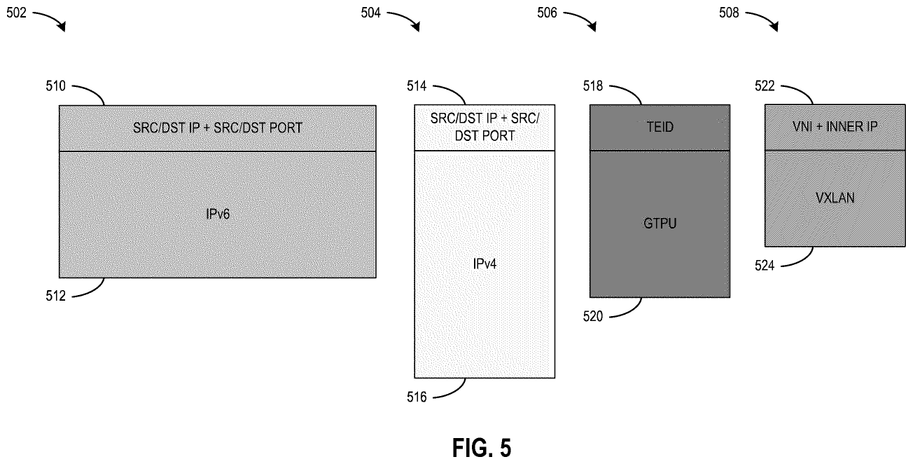

Example structured hardware representations of flow tables are illustrated and described in connection with FIG. 5. In the example of FIG. 3, a structured hardware representation of a flow table may vary depending on the specific CAM architecture of a hardware vendor. For example, in the case of an IPU provided by Intel Corporation, the IPU utilizes an 11-bit value to represent a packet type parameter or a group of packet type parameters. Additionally, the IPU provided by Intel Corporation utilizes a 16-bit word vector selected by a set of protocol and/or offset pairs to represent a key field parameter. Network devices provided by other hardware vendors may utilize different sized values for packet type and key field parameters.

As described herein, the parameter conversion circuitry 304 bridges user intent and hardware specific CAM configurations. For example, parameter normalization performed by the parameter conversion circuitry 304 ensures that the intent of a user is comprehensively understood and translated into a hardware-specific format. Additionally, the adaptability to various input formats and hardware vendors provided by the parameter conversion circuitry 304 allows example CAM configuration performed by the memory configuration control circuitry 116 to be highly versatile and user-friendly, regardless of the level of expertise of a user.

In the illustrated example of FIG. 3, the configuration generation circuitry 306 is coupled to the parameter conversion circuitry 304, the configuration evaluation circuitry 308, and the CAM 114. In the example of FIG. 3, the configuration generation circuitry 306 explores candidate configurations of the CAM 114 to implement the one or more structured hardware representations generated by the parameter conversion circuitry 304. Example configuration exploration performed by the configuration generation circuitry 306 includes reducing a search space for candidate configurations for the CAM 114, generating candidate configurations for the CAM 114, mapping structured hardware representations of flow tables to the candidate configurations, and verifying the feasibility of the mappings.

In the illustrated example of FIG. 3, techniques to reduce the search space for candidate configuration for the CAM 114 include constraint propagation, rule compression, and slice and hardware representation grouping. For example, one of the challenges of exploring TCAM configurations lays in devising a practical technique to efficiently explore the massive number of possibilities for assigning flow tables to TCAM slices. As the number of flow tables and TCAM slices increases, a brute-force approach becomes infeasible due to the exponential growth in the number of potential configurations. For example, attempting to allocate sixteen flow tables to a TCAM configuration comprising eight TCAM slices leads to 8\hat{ }16 (e.g., more than 128 trillion) candidate TCAM configurations.

In the illustrated example of FIG. 3, constraint propagation includes the configuration generation circuitry 306 identifying and eliminating, early in the configuration search, candidate configurations of the CAM 114 that are infeasible. By doing so, the configuration generation circuitry 306 reduces computational complexity of configuration exploration by preventing processing to evaluate candidate configurations that are infeasible. In the example of FIG. 3, constraint propagation includes the configuration generation circuitry 306 excluding one or more configurations of the CAM 114 from further processing if the one or more configurations are incapable of supporting the hardware representation of at least one flow table.

For example, if a slice of the CAM 114 that is utilized in a candidate configuration is not wide enough to accommodate the size of a key field of a hardware representation of a flow table, then the configuration generation circuitry 306 can exclude the candidate configuration from further processing. As such, example constraint propagation narrows (e.g., significantly) the search space during configuration exploration. Thus, when the configuration generation circuitry 306 generates candidate configurations from the narrowed search space, the number of unique configurations will be reduced.

In the illustrated example of FIG. 3, rule compression includes the configuration generation circuitry 306 merging hardware representations of multiple flow tables into a single hardware representation to effectively reduce the search space to be explored during configuration exploration. In the example of FIG. 3, when two flow tables share overlapping packet type parameters to be resolved based on respective priority parameters, the configuration generation circuitry 306 combines the hardware representation of the two flow tables into a composite hardware representation. For example, based on a second flow table sharing packet type with a first flow table and having a second priority different than a first priority of the first flow table, the configuration generation circuitry 306 combines a first hardware representation of the first flow table and a second hardware representation of the second flow table into a composite hardware representation. In the composite hardware representation, the configuration generation circuitry 306 arranges information for the flow table having a higher priority to precede information for the flow table having a lower priority.

In the illustrated example of FIG. 3, grouping of slices and hardware representations includes the configuration generation circuitry 306 grouping slices of CAM 114 and hardware representations by shape. For example, the configuration generation circuitry 306 (1) categorizes slices of the CAM 114 into groups based on shape and (2) categorizes hardware representations into groups based on key field parameter sizes and minimum rule number parameters. As such, if the configuration generation circuitry 306 exchanges mapping results of two hardware representations from the same category, the configuration generation circuitry 306 does not violate the user-provided parameters.

In the illustrated example of FIG. 3, example candidate configuration exploration includes the configuration generation circuitry 306 generating a comprehensive list of candidate configurations of the CAM 114. For example, the configuration generation circuitry 306 generates the comprehensive list of candidate configurations of the CAM 114 from the search space (e.g., reduced or non-reduced) based on the vendor-specific sizes of the slices of the CAM 114. In the example of FIG. 3, the configuration generation circuitry 306 exhaustively generates a range of candidate configurations for the CAM 114 to provide a pool of configuration options for consideration.

In the illustrated example of FIG. 3, the comprehensive list of candidate configurations generated by the configuration generation circuitry 306 is represented as a matrix of the possible configurations (e.g., as illustrated in FIG. 2). In the example of FIG. 3, configuration exploration performed by the configuration generation circuitry 306 produces a comprehensive list of candidate configurations of the CAM 114 that are feasible for a given hardware platform. Additionally, in the example of FIG. 3, the configuration generation circuitry 306 maps hardware representations to the candidate configurations.

In the illustrated example of FIG. 3, example mapping of hardware representations to the candidate configurations includes the configuration generation circuitry 306 fitting hardware representations to the candidate configurations. For example, based on the dimensions of the hardware representations and the dimensions of the slices of the CAM 114 in the candidate configurations, the configuration generation circuitry 306 fits the hardware representations to the candidate configurations. That is, for each candidate configuration of the CAM 114, the configuration generation circuitry 306 maps or fits the hardware configurations to the candidate configuration of the CAM 114.

Example mapping of hardware representations to candidate configurations ensures that the hardware representation of each flow table is allocated (e.g., optimally) among available resources of the CAM 114. For example, the configuration generation circuitry 306 ensures that the key field parameter, priority parameter, and packet type parameter of the hardware representation of each flow table align (e.g., optimally) with the capabilities of available slices of the CAM 114. As described herein, the configuration generation circuitry 306 implements one or more search techniques to systematically explore and identify feasible configurations of the CAM 114 to which the hardware representations of flow tables provided by the parameter conversion circuitry 304 are to be mapped.

In the illustrated example of FIG. 3, example feasibility verification includes the configuration generation circuitry 306 assessing whether a hardware representation of a flow table, the key field parameter of the flow table, and the priority parameter of the flow table align with the capabilities of one or more slices of the CAM 114 to which the hardware representation is mapped. For example, the configuration generation circuitry 306 verifies that the height and width (e.g., the key field parameter) of a hardware representation of a flow table fits within the size or footprint of the one or more slices of the CAM 114 utilized in a candidate configuration. Additionally or alternatively, the configuration generation circuitry 306 verifies that when a packet matches multiple flow tables, flow tables having higher priorities process the packet before flow tables having lower priorities. As such, the configuration generation circuitry 306 ensures that a candidate configuration for the CAM 114 satisfies user-defined parameters.

In the illustrated example of FIG. 3, the configuration evaluation circuitry 308 is coupled to the configuration generation circuitry 306, the memory configuration circuitry 310, and the CAM 114. As described herein, the configuration generation circuitry 306 generates candidate configurations of the CAM 114 that (1) satisfy the parameters received by the parameter interface circuitry 302 and (2) are specific to the hardware of the CAM 114. In the example of FIG. 3, the configuration evaluation circuitry 308 evaluates the candidate configurations provided by the configuration generation circuitry 306.

In the illustrated example of FIG. 3, configuration evaluation includes the configuration evaluation circuitry 308 performing a comparative analysis of the candidate configurations to select a candidate configuration that best satisfies the user-provided parameters. For example, the configuration evaluation circuitry 308 implements a multi-dimensional scoring technique to evaluate aspects of each candidate configuration provided by the configuration generation circuitry 306. Example aspects considered by the configuration evaluation circuitry 308 include performance characteristics such as power efficiency of a configuration, network performance for a configuration, and rule capacity of a configuration.

In the illustrated example of FIG. 3, the configuration evaluation circuitry 308 determines a score for each candidate configuration of the CAM 114. For example, the configuration evaluation circuitry 308 scores candidate configurations according to a vector space that encodes aspects of the candidate configurations (e.g., power efficiency, network performance, and the number of accommodated rules). In the example of FIG. 3, the configuration evaluation circuitry 308 scores each candidate configuration under consideration based on the encoded aspects, resulting in a vector of scores (also referred to as a score vector).

In the illustrated example of FIG. 3, the configuration evaluation circuitry 308 weighs scores for candidate configurations based on a user-provided weight vector. For example, a user (e.g., a network administrator) provides an example weight vector including weights to prioritize different aspects of candidate configurations during selection of a configuration for the CAM 114. A user-provided weight vector assigns importance to each aspect of a candidate configuration for which the candidate configuration is scored in a score vector. Thus, a user-provided weight vector reflects priorities of the user. Based on the weight vector, the configuration evaluation circuitry 308 generates a composite score for each candidate configuration of the CAM 114.

For example, the configuration evaluation circuitry 308 determines (e.g., computes) a dot product between the score vector of a candidate configuration and the weight vector provided by a user. In this manner, the configuration evaluation circuitry 308 determines (e.g., computes) a composite score vector including the composite score for each candidate configuration. In the example of FIG. 3, the configuration evaluation circuitry 308 identifies and/or otherwise selects a candidate configuration having a highest composite score, as determined via weighted scoring, among the candidate configurations. As described above, the composite scores of the candidate configurations are based on respective performance characteristics of the candidate configurations. Thus, the configuration evaluation circuitry 308 selects one of the candidate configurations based on respective performance characteristics of the candidate configurations.

As such, the configuration evaluation circuitry 308 accommodates user preferences and intentions by applying the weight vector to the score vectors. In this manner, the configuration evaluation circuitry 308 provides precise alignment with user preferences (e.g., weighting) whether emphasizing power efficiency, network performance, or accommodation of rules. By incorporating multi-dimensional scoring and weighting, the configuration evaluation circuitry 308 ensures that the selected configuration for the CAM 114 aligns precisely with the intentions and objectives of a user, offering a level of customization and optimization to users.

In the illustrated example of FIG. 3, the memory configuration circuitry 310 is coupled to the configuration evaluation circuitry 308 and the CAM 114. As described herein, the configuration evaluation circuitry 308 provides a configuration to the memory configuration circuitry 310. In the example of FIG. 3, the memory configuration circuitry 310 configures the CAM 114 according to the configuration provided by the configuration evaluation circuitry 308. For example, the memory configuration circuitry 310 programs the CAM 114 to stack a variety of slices of the CAM 114 according to the selected configuration.

In the illustrated example of FIG. 3, after the CAM 114 is configured and/or programmed with a particular configuration, one or more flow tables represented on the hardware of the CAM 114 can be programmed with one or more rules and/or utilized for rule matching. For example, returning to FIG. 1, to program one or more rules onto the CAM 114, a control plane process of the programmable circuitry 102 sends a command to the network device 106. Example commands include rules such as “match all VXLAN packets from port 0 with an inner IPv4 address of 255.x.x.x and drop them.”

Based on a command received from the programmable circuitry 102, the packet processor circuitry 110 (e.g., a driver of the packet processor circuitry 110) identifies the packet type targeted by a rule (e.g., VXLAN packet with inner IPv4). The packet processor circuitry 110 encodes the packet type into a unique index that can be used to look up the corresponding key fields (e.g., ingress port 0 and IPv4 address of 255.x.x.x) and target rule (e.g., to drop matching packets) in the hardware representation of the flow table stored on the CAM 114. Additionally, the packet processor circuitry 110 extracts the key fields from the command and programs the key field into an unused line of the hardware representation of the flow table stored on the CAM 114.

In the illustrated example of FIG. 1, to perform rule matching for received packets, the packet processor circuitry 110 processes a packet to determine a packet type for the packet. The packet processor circuitry 110 queries the CAM 114 with the packet type. Based on the packet type, the CAM 114 looks up the key field and hardware representation of a flow table corresponding to the packet type. The CAM 114 returns the key field to the packet processor circuitry 110.

In the illustrated example of FIG. 1, the packet processor circuitry 110 extracts a value of the key field from the packet and provides the value to the CAM 114. Using the value of the key field from the packet, the CAM 114 performs a matching operation to identify one or more rules from the hardware representation of the flow table and returns the one or more rules to the packet processor circuitry 110. In the example of FIG. 1, the packet processor circuitry 110 processes the packet according to the one or more rules.

Returning to FIG. 3, as described herein, the memory configuration control circuitry 116 performs TCAM resource configuration for efficient network resources (e.g., networks controllers, routers, switches, etc.). Additionally, as described herein, one or more of the components of the memory configuration control circuitry 116 can be implemented as at least one of hardware, software, or firmware. For example, one or more of the components of the memory configuration control circuitry 116 can be implemented as software and/or firmware that analyzes flow offloading parameters for a network resource (e.g., a NIC, an IPU, etc.) and generates a TCAM configuration recipe. In some examples, one or more of the components of the memory configuration control circuitry 116 are implemented as software and/or firmware of a host computer that receives requests from one or more virtual control functions for wildcard match configuration and TCAM programming. Additionally or alternatively, one or more of the components of the memory configuration control circuitry 116 are implemented as source code (e.g., a Linux kernel driver, a DPDK poll mode driver (PMD), a P4 compiler, etc.).

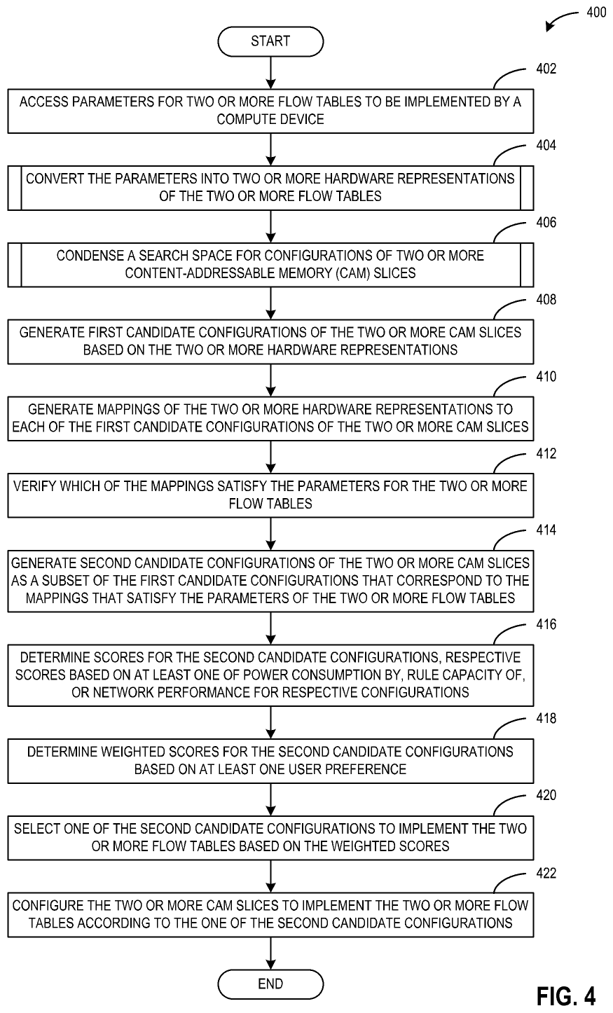

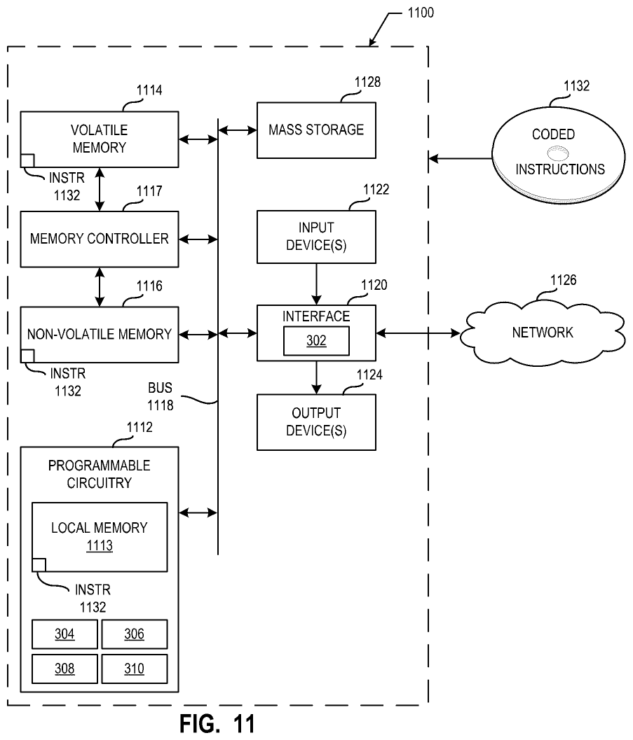

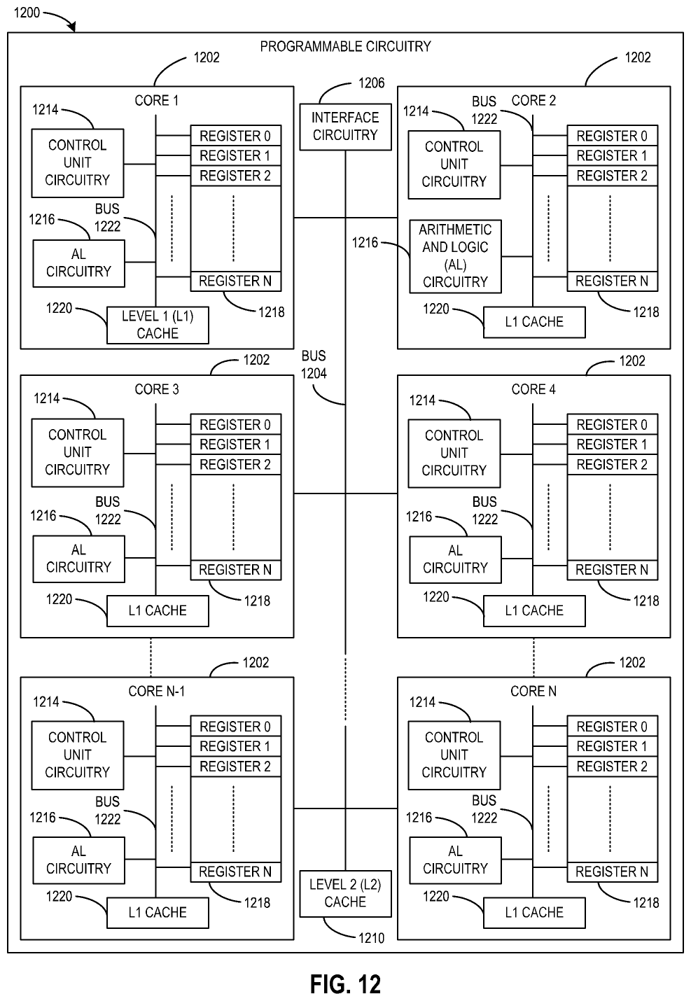

In some examples, the parameter interface circuitry 302 is instantiated by programmable circuitry executing parameter interfacing instructions and/or configured to perform operations such as those represented by the flowchart(s) of FIG. 4. In some examples, the memory configuration control circuitry 116 includes means for accessing parameters for two or more flow tables. For example, the means for accessing may be implemented by the parameter interface circuitry 302. In some examples, the parameter interface circuitry 302 may be instantiated by programmable circuitry such as the example programmable circuitry 1112 of FIG. 11. For instance, the parameter interface circuitry 302 may be instantiated by the example microprocessor 1200 of FIG. 12 executing machine-executable instructions such as those implemented by at least block 402 of FIG. 4.

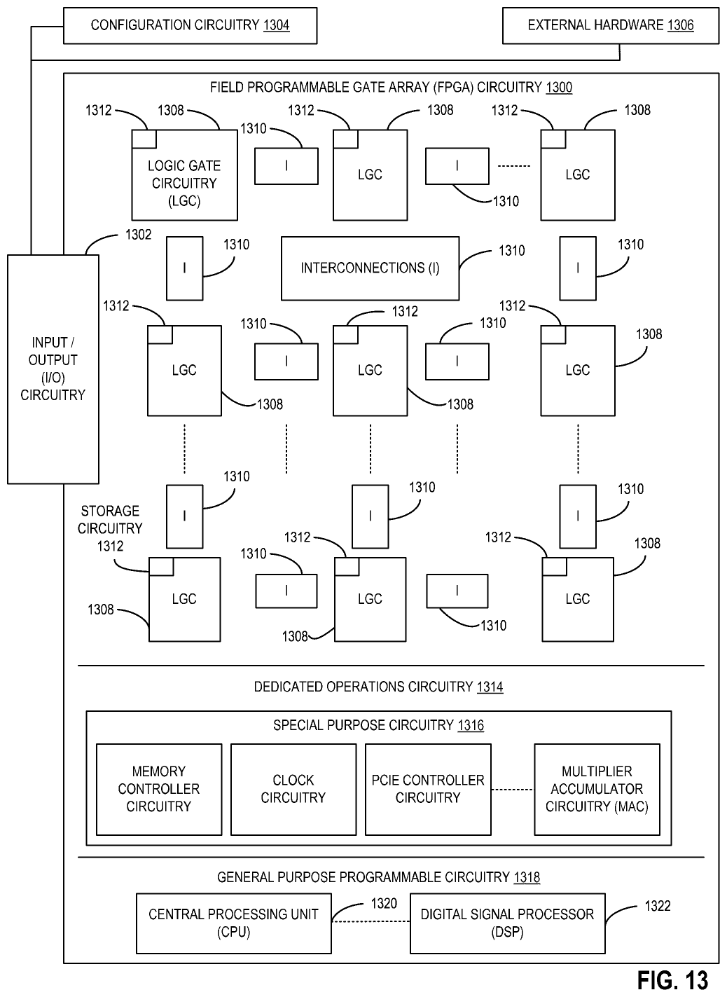

In some examples, the parameter interface circuitry 302 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the parameter interface circuitry 302 may be instantiated by any other combination of hardware, software, and/or firmware. For example, the parameter interface circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

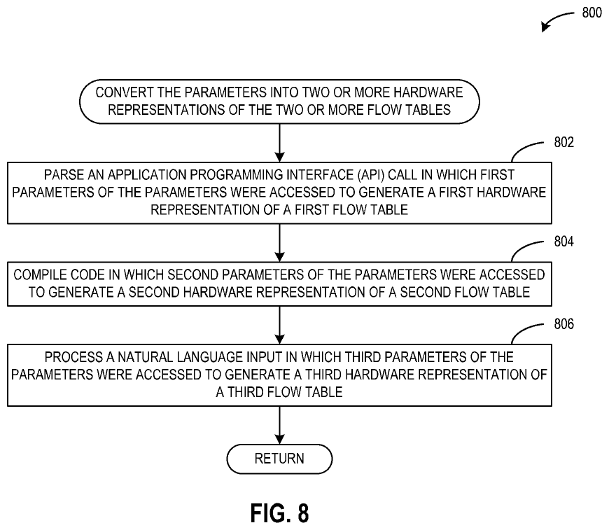

In some examples, the parameter conversion circuitry 304 is instantiated by programmable circuitry executing parameter conversion instructions and/or configured to perform operations such as those represented by the flowchart(s) of FIGS. 4 and/or 8. In some examples, the memory configuration control circuitry 116 includes means for converting parameters for two or more flow tables into two or more hardware representations of the two or more flow tables. For example, the means for converting may be implemented by the parameter conversion circuitry 304. In some examples, the parameter conversion circuitry 304 may be instantiated by programmable circuitry such as the example programmable circuitry 1112 of FIG. 11. For instance, the parameter conversion circuitry 304 may be instantiated by the example microprocessor 1200 of FIG. 12 executing machine-executable instructions such as those implemented by at least block 404 of FIG. 4 and/or at least blocks 802, 804, and 806 of FIG. 8.

In some examples, the parameter conversion circuitry 304 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the parameter conversion circuitry 304 may be instantiated by any other combination of hardware, software, and/or firmware. For example, the parameter conversion circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

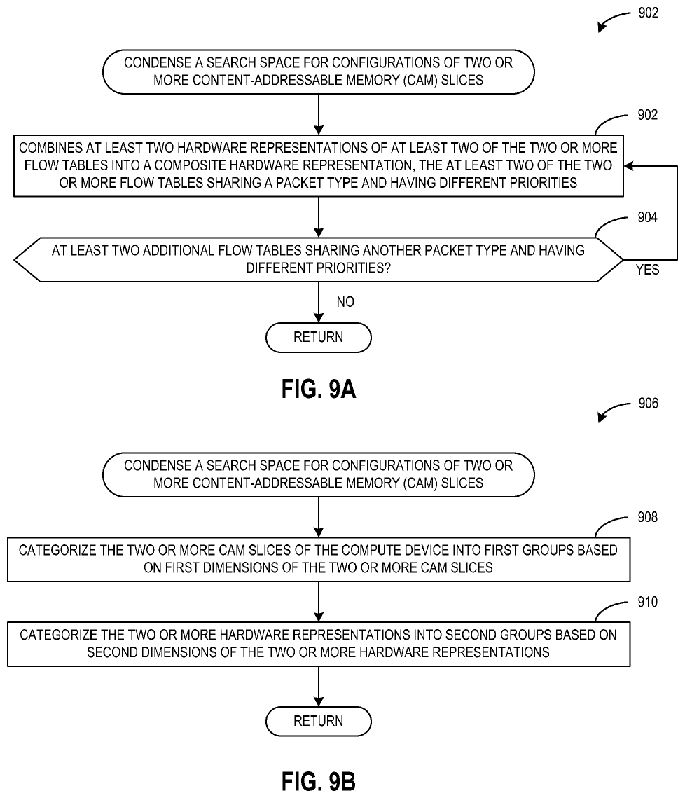

In some examples, the configuration generation circuitry 306 is instantiated by programmable circuitry executing configuration generation instructions and/or configured to perform operations such as those represented by the flowchart(s) of FIGS. 4, 9A, and/or 9B. In some examples, the memory configuration control circuitry 116 includes means for generating candidate configurations of two more CAM slices. For example, the means for generating may be implemented by the configuration generation circuitry 306. In some examples, the configuration generation circuitry 306 may be instantiated by programmable circuitry such as the example programmable circuitry 1112 of FIG. 11. For instance, the configuration generation circuitry 306 may be instantiated by the example microprocessor 1200 of FIG. 12 executing machine-executable instructions such as those implemented by at least blocks 406, 408, 410, 412, and 414 of FIG. 4, at least blocks 902 and 904 of FIG. 9A, and/or at least blocks 908 and 910 of FIG. 9B.

In some examples, the configuration generation circuitry 306 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the configuration generation circuitry 306 may be instantiated by any other combination of hardware, software, and/or firmware. For example, the configuration generation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the configuration evaluation circuitry 308 is instantiated by programmable circuitry executing configuration evaluation instructions and/or configured to perform operations such as those represented by the flowchart(s) of FIG. 4. In some examples, the memory configuration control circuitry 116 includes means for selecting a candidate configuration of two or more CAM slices. For example, the means for selecting may be implemented by the configuration evaluation circuitry 308. In some examples, the configuration evaluation circuitry 308 may be instantiated by programmable circuitry such as the example programmable circuitry 1112 of FIG. 11. For instance, the configuration evaluation circuitry 308 may be instantiated by the example microprocessor 1200 of FIG. 12 executing machine-executable instructions such as those implemented by at least blocks 416, 418, and 420 of FIG. 4.

In some examples, the configuration evaluation circuitry 308 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the configuration evaluation circuitry 308 may be instantiated by any other combination of hardware, software, and/or firmware. For example, the configuration evaluation circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the memory configuration circuitry 310 is instantiated by programmable circuitry executing memory configuration instructions and/or configured to perform operations such as those represented by the flowchart(s) of FIG. 4. In some examples, the memory configuration control circuitry 116 includes means for configuring two or more CAM slices. For example, the means for configuring may be implemented by the memory configuration circuitry 310. In some examples, the memory configuration circuitry 310 may be instantiated by programmable circuitry such as the example programmable circuitry 1112 of FIG. 11. For instance, the memory configuration circuitry 310 may be instantiated by the example microprocessor 1200 of FIG. 12 executing machine-executable instructions such as those implemented by at least block 422 of FIG. 4.

In some examples, the memory configuration circuitry 310 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the memory configuration circuitry 310 may be instantiated by any other combination of hardware, software, and/or firmware. For example, the memory configuration circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the memory configuration control circuitry 116 of FIG. 1 is illustrated in FIG. 3, one or more of the elements, processes, and/or devices illustrated in FIG. 3 may be combined, divided, re-arranged, omitted, eliminated, and/or implemented in any other way. Further, the example parameter interface circuitry 302, the example parameter conversion circuitry 304, the example configuration generation circuitry 306, the example configuration evaluation circuitry 308, the example memory configuration circuitry 310, and/or, more generally, the example memory configuration control circuitry 116 of FIG. 3, may be implemented by hardware alone or by hardware in combination with software and/or firmware. Thus, for example, any of the example parameter interface circuitry 302, the example parameter conversion circuitry 304, the example configuration generation circuitry 306, the example configuration evaluation circuitry 308, the example memory configuration circuitry 310, and/or, more generally, the example memory configuration control circuitry 116, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example memory configuration control circuitry 116 of FIG. 3 may include one or more elements, processes, and/or devices in addition to, or instead of, those illustrated in FIG. 3, and/or may include more than one of any or all of the illustrated elements, processes, and devices.

Flowchart(s) representative of example machine-readable instructions, which may be executed by programmable circuitry to implement and/or instantiate the memory configuration control circuitry 116 of FIG. 3 and/or representative of example operations which may be performed by programmable circuitry to implement and/or instantiate the memory configuration control circuitry 116 of FIG. 3, are shown in FIGS. 4, 8, 9A, and 9B. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device).

For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4, 8, 9A, and 9B, many other methods of implementing the example memory configuration control circuitry 116 may alternatively be used.

For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)).

As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4, 8, 9A, and 9B may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information).

As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 is a flowchart representative of example machine-readable instructions and/or example operations 400 that may be executed, instantiated, and/or performed by example programmable circuitry to implement the memory configuration control circuitry 116 of FIGS. 1 and/or 3. The example machine-readable instructions and/or the example operations 400 of FIG. 4 begin at block 402, at which the parameter interface circuitry 302 accesses parameters for two or more flow tables to be implemented by a compute device. For example, the memory configuration control circuitry 116 is to utilize the parameters to configure the CAM 114.

In the illustrated example of FIG. 4, at block 404, the parameter conversion circuitry 304 converts the parameters into two or more hardware representations of the two or more flow tables. For example, based on parameters to be used to configure a compute device to implement two or more flow tables, the parameter conversion circuitry 304 converts the parameters into two or more hardware representations of the two or more flow tables. Example machine-readable instructions and/or example operation to implement block 404 are illustrated and described in connection with FIG. 8. FIG. 5 is a block diagram of example hardware representations 502-508 of flow tables to be programmed onto one or more TCAM slices.

In the illustrated example of FIG. 5, the hardware representations 502-508 correspond to different network protocols. For example, the hardware representation 502 corresponds to a flow table for IPv6. In the example of FIG. 5, the hardware representation 502 includes an example key field 510 and an example body 512. For example, the key field 510 identifies the source IP address, the destination IP address, the source port, and/or the destination port as key fields of a packet. In the example of FIG. 5, the body 512 stores one or more rules of the hardware representation 502. Also, the height of the body 512 is based on the minimum rule number parameter of the flow table and the width of the body is based on the size of the key field 510.

In the illustrated example of FIG. 5, the hardware representation 504 corresponds to a flow table for IPv4. In the example of FIG. 5, the hardware representation 504 includes an example key field 514 and an example body 516. For example, the key field 514 identifies the source IP address, the destination IP address, the source port, and/or the destination port as key fields of a packet. In the example of FIG. 5, the body 516 stores one or more rules of the hardware representation 504. Also, the height of the body 516 is based on the minimum rule number parameter of the flow table and the width of the body is based on the size of the key field 514.

In the illustrated example of FIG. 5, the hardware representation 506 corresponds to a flow table for a general packet radio service (GPRS) tunneling protocol (GTP) user (GTPU). In the example of FIG. 5, the hardware representation 506 includes an example key field 518 and an example body 520. For example, the key field 518 identifies the tunnel endpoint identifier (TEID) as a key field of a packet. In the example of FIG. 5, the body 520 stores one or more rules of the hardware representation 506. Also, the height of the body 520 is based on the minimum rule number parameter of the flow table and the width of the body is based on the size of the key field 518.

In the illustrated example of FIG. 5, the hardware representation 508 corresponds to a flow table for VXLAN. In the example of FIG. 5, the hardware representation 508 includes an example key field 522 and an example body 524. For example, the key field 522 identifies the VXLAN network identifier (VNI) and inner IP address as key fields of a packet. In the example of FIG. 5, the body 524 stores one or more rules of the hardware representation 508. Also, the height of the body 524 is based on the minimum rule number parameter of the flow table and the width of the body is based on the size of the key field 522.

Returning to the illustrated example of FIG. 4, at block 406, the configuration generation circuitry 306 condenses a search space for configurations of two or more CAM slices (e.g., two or more content-addressable memory slices). Example machine-readable instructions and/or example operations to implement block 406 are illustrated and described in connection with FIGS. 9A and 9B. In the example of FIG. 4, at block 408, the configuration generation circuitry 306 generates first candidate configurations of the two or more CAM slices based on the two or more hardware representations.

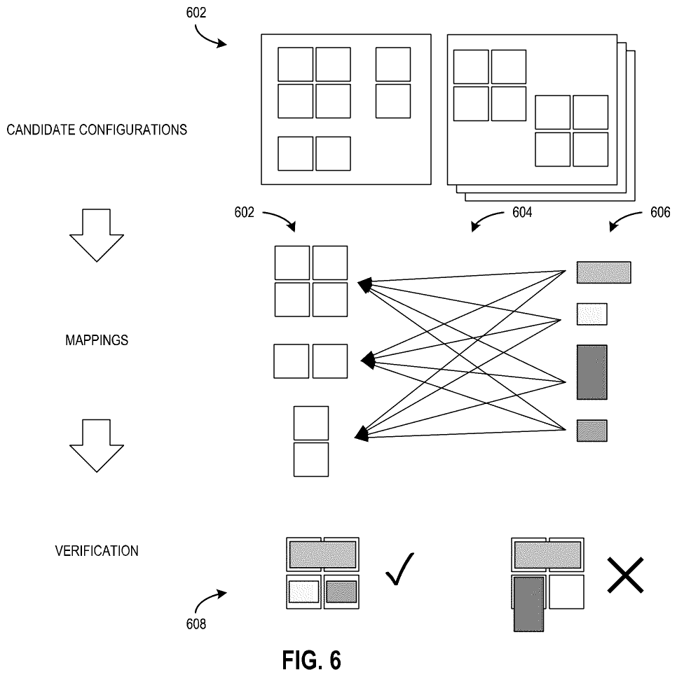

In the illustrated example of FIG. 4, at block 410, the configuration generation circuitry 306 generates mappings of the two or more hardware representations to each of the first candidate configurations of the two or more CAM slices. In the example of FIG. 4, at block 412, the configuration generation circuitry 306 verifies which of the mappings satisfy the parameters for the two or more flow tables. FIG. 6 is a block diagram illustrating example candidate configurations 602 of TCAM slices, example mappings 604 of example hardware representations 606 to each of the candidate configurations 602, and example verification 608 of the mappings 604.

Returning to the illustrated example of FIG. 4, at block 414, the configuration generation circuitry 306 generates second candidate configurations of the two or more CAM slices as a subset of the first candidate configurations. For example, the second candidate configurations are a subset of the first candidate configurations that correspond to the mappings that satisfy the parameters of the two or more flow tables. In the example of FIG. 4, at block 416, the configuration evaluation circuitry 308 determines scores for the second candidate configurations. For example, respective scores for the second candidate configurations are based on at least one of power consumption by, rule capacity of, or network performance for respective configurations of the second candidate configurations.

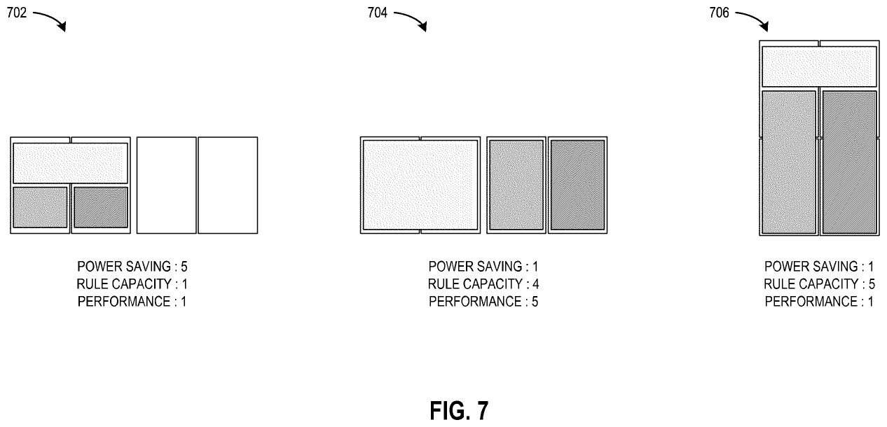

FIG. 7 is a block diagram of example candidate configurations 702-706 having different score vectors. In the example of FIG. 7, the score vector for each of the candidate configurations 702-706 includes scores for power savings, rule capacity, and network performance. For example, the score vector for the candidate configuration 702 is [5, 1, 1], the score vector for the candidate configuration 704 is [1, 4, 5], and the score vector for the candidate configuration 706 is [1, 5, 1].

Returning to the illustrated example of FIG. 4, at block 418, the configuration evaluation circuitry 308 determines weighted scores for the second candidate configurations based on at least one user preference. For example, the at least one user preference is defined in a weight vector as described above. Equation 1 illustrates a composite score vector determined by the configuration evaluation circuitry 308 as a dot product between the score vectors of FIG. 7 and a weight vector of [1, 2, 1].

$$[ \begin{matrix}5 & 1 & 1 \\ 1 & 4 & 5 \\ 1 & 5 & 1\end{matrix} ] \cdot [ \begin{matrix}1 \\ 2 \\ 1\end{matrix} ] = [ \begin{matrix}8 \\ 14 \\ 12\end{matrix} ] \qquad Equation 1$$

In the illustrated example of FIG. 4, at block 420, the configuration evaluation circuitry 308 selects one of the second candidate configurations to implement the two or more flow tables based on the weighted scores. For example, according to Equation 1 above, the configuration evaluation circuitry 308 identifies and/or otherwise selects the candidate configuration corresponding to the second row of the composite score vector (e.g., the candidate configuration 704). At block 422, the memory configuration circuitry 310 configures the two or more CAM slices to implement the two or more flow tables according to the selected one of the second candidate configurations.

FIG. 8 is a flowchart representative of example machine-readable instructions and/or example operations 800 that may be executed, instantiated, and/or performed by example programmable circuitry to implement the memory configuration control circuitry 116 of FIGS. 1 and/or 3 to convert parameters for two or more flow tables into two or more hardware representations of the two or more flow tables. For example, the machine-readable instructions and/or the operations 800 can be executed, instantiated, and/or performed to implement block 404 of the machine-readable instructions and/or the operations 400 of FIG. 4. The example machine-readable instructions and/or the example operations 800 of FIG. 8 begin at block 802, at which the parameter conversion circuitry 304 parses an API call in which first parameters of the parameters were accessed to generate a first hardware representation of a first flow table. For example, the parameter conversion circuitry 304 implements a parsing scripter to generate the first hardware representation.

In the illustrated example of FIG. 8, at block 804, the parameter conversion circuitry 304 compiles code in which second parameters of the parameters were accessed to generate a second hardware representation of a second flow table. For example, the parameter conversion circuitry 304 implements a compiler to generate the second hardware representation. In the example of FIG. 8, at block 806, the parameter conversion circuitry 304 processes a natural language input in which third parameters of the parameters were accessed to generate a third hardware representation of a third flow table. For example, the parameter conversion circuitry 304 implements a machine learning model such as an LLM to generate the third hardware representation.

FIG. 9A is a flowchart representative of example machine-readable instructions and/or example operations 900 that may be executed, instantiated, and/or performed by example programmable circuitry to implement the memory configuration control circuitry 116 of FIGS. 1 and/or 3 to condense a search space for configurations of two more CAM slices. For example, the machine-readable instructions and/or the operations 900 can be executed, instantiated, and/or performed to implement block 406 of the machine-readable instructions and/or the operations 400 of FIG. 4. The example machine-readable instructions and/or the example operations 900 of FIG. 9A begin at block 902, at which the configuration generation circuitry 306 combines at least two hardware representations of at least two of the two or more flow tables into a composite hardware representation. For example, the at least two of the two or more flow tables share a packet type and have different priorities.

In the illustrated example of FIG. 9A, at block 904, the configuration generation circuitry 306 determines whether there are at least two additional flow tables sharing another packet type and having different priorities. Based on (e.g., in response to) the configuration generation circuitry 306 determining that there are at least two additional flow tables sharing another packet type and having different priorities (block 904: YES), the machine-readable instructions and/or the operations 900 return to block 902. Based on (e.g., in response to) the configuration generation circuitry 306 determining that there are not at least two additional flow tables sharing another packet type and having different priorities (block 904: NO), the machine-readable instructions and/or the operations 900 return to the machine-readable instructions and/or the operations 400 at block 408. For example, at block 408, the configuration generation circuitry 306 generates the first candidate configurations of the two or more hardware representations including the at least one composite hardware representation.

FIG. 9B is a flowchart representative of example machine-readable instructions and/or example operations 906 that may be executed, instantiated, and/or performed by example programmable circuitry to implement the memory configuration control circuitry 116 of FIGS. 1 and/or 3 to condense a search space for configurations of two more CAM slices. For example, the machine-readable instructions and/or the operations 906 can be executed, instantiated, and/or performed to implement block 406 of the machine-readable instructions and/or the operations 400 of FIG. 4. The example machine-readable instructions and/or the example operations 906 of FIG. 9B begin at block 908, at which the configuration generation circuitry 306 categorizes the two or more CAM slices of the compute device into first groups based on first dimension of the two or more CAM slices. At block 910, the configuration generation circuitry 306 categorizes the two or more hardware representations into second groups based on second dimensions of the two or more hardware representations.

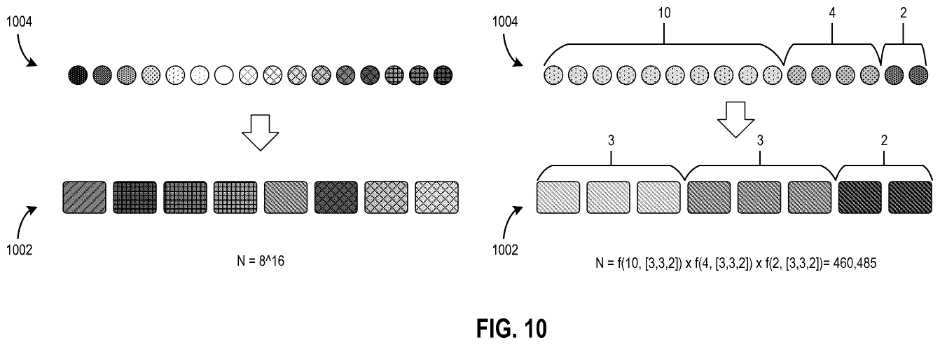

FIG. 10 is a graphical illustration depicting how grouping example candidate configurations 1002 of two or more CAM slices and example hardware representations 1004 by shape reduces the computational burden of performing CAM configuration search. As illustrated in FIG. 10, if (1) there are eight of the candidate configuration 1002 and the candidate configurations 1002 can be categorized into groups of 3, 3, and 2 and (2) there are 16 of the hardware representations 1004 and the hardware representations 1004 can be categorized into groups of 2, 4, and 10, the search space for CAM configuration searching can be drastically reduced from 8\hat{ }16 unique CAM configurations to 460,485 unique CAM configurations. For example, the hardware representations 1004 are grouped based on the key field parameter sizes and minimal rule numbers.

Returning to the illustrated example of FIG. 9B, after block 910, the machine-readable instructions and/or the operations 906 return to the machine-readable instructions and/or the operations 400 at block 408. For example, at block 408, the configuration generation circuitry 306 generates the first candidate configurations of the two or more CAM slices based on the first groups and the second groups. As such, grouping candidate configurations of two or more CAM slices and hardware representations by shape reduces the computational burden of performing CAM configuration searching.

FIG. 11 is a block diagram of an example programmable circuitry platform 1100 structured to execute and/or instantiate the example machine-readable instructions and/or the example operations of FIGS. 4, 8, 9A, and 9B to implement the memory configuration control circuitry 116 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example parameter conversion circuitry 304, the example configuration generation circuitry 306, the example configuration evaluation circuitry 308, and the example memory configuration circuitry 310.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example the interface circuitry 1120 implements the example parameter interface circuitry 302.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 4, 8, 9A, and 9B, may be stored in the mass storage device 1128, in the volatile memory 1114, in the non-volatile memory 1116, and/or on at least one non-transitory computer-readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 4, 8, 9A, and 9B to effectively instantiate the circuitry of FIG. 3 as logic circuits to perform operations corresponding to those machine-readable instructions. In some such examples, the circuitry of FIG. 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 4, 8, 9A, and 9B.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry 1216 (sometimes referred to as an ALU), a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 4, 8, 9A, and 9B but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4, 8, 9A, and 9B. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 8, 9A, and 9B. As such, the FPGA circuitry 1300 may be configured and/or structured to effectively instantiate some or all of the operations/functions corresponding to the machine-readable instructions of the flowchart(s) of FIGS. 4, 8, 9A, and 9B as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 4, 8, 9A, and 9B faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13 includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 4, 8, 9A, and 9B and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 4, 8, 9A, and 9B to perform first operation(s)/function(s), the FPGA circuitry 1300 of FIG. 13 may be configured and/or structured to perform second operation(s)/function(s) corresponding to a second portion of the machine-readable instructions represented by the flowcharts of FIGS. 4, 8, 9A, and 9B, and/or an ASIC may be configured and/or structured to perform third operation(s)/function(s) corresponding to a third portion of the machine-readable instructions represented by the flowcharts of FIGS. 4, 8, 9A, and 9B.

It should be understood that some or all of the circuitry of FIG. 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 3 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

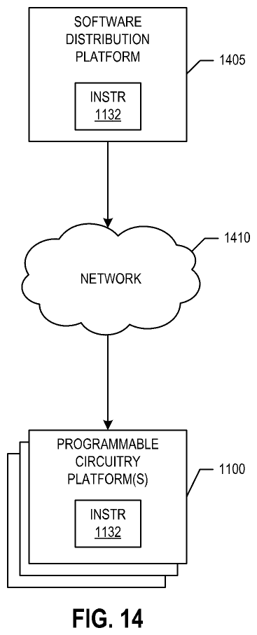

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 4, 8, 9A, and 9B, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine-readable instructions of FIGS. 4, 8, 9A, and 9B, may be downloaded to the example programmable circuitry platform 1100, which is to execute the machine-readable instructions 1132 to implement the memory configuration control circuitry 116. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry (e.g., at least one programmable circuit) include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce the computational complexity and computational burden to perform TCAM configuration. Disclosed systems, apparatus, articles of manufacture, and methods improve the efficiency of using a computing device by improving the efficiency and scalability of network hardware (e.g., NICs, IPUs, SoCs, etc.), for example, by determining TCAM configurations best suited for a particular application given user parameters and priorities. Examples disclosed herein also facilitate routing in the case of a multi-host and/or multi-control plane environment. Accordingly, examples disclosed herein provide robust, cost-effective network solutions. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to configure content-addressable memory resources are disclosed herein. Further examples and combinations thereof include the following:

Example 1 includes an apparatus comprising interface circuitry to access parameters to be used to configure content-addressable memory (CAM) of a compute device to implement a packet flow table, machine-readable instructions, and at least one programmable circuit to be programmed by the machine-readable instructions to convert the parameters into a hardware representation of the packet flow table, generate, based on the hardware representation, candidate configurations of two or more CAM slices of the compute device that satisfy the parameters, select one of the candidate configurations of the two or more CAM slices to implement the packet flow table based on respective performance characteristics of the candidate configurations, and configure the two or more CAM slices based on the selected one of the candidate configurations.

Example 2 includes the apparatus of example 1, wherein the candidate configurations are first candidate configurations, and one or more of the at least one programmable circuit is to generate second candidate configurations of the two or more CAM slices based on the hardware representation, generate mappings of the hardware representation to each of the second candidate configurations of the two or more CAM slices, verify which of the mappings satisfy the parameters for the packet flow table, and generate the first candidate configurations of the two or more CAM slices as a subset of the second candidate configurations that correspond to the mappings that satisfy the parameters of the packet flow table.

Example 3 includes the apparatus of example 2, wherein the packet flow table is a first packet flow table, the hardware representation is a first hardware representation, and one or more of the at least one programmable circuit is to categorize the two or more CAM slices of the compute device into one or more first groups based on first dimensions of the two or more CAM slices, categorize at least the first hardware representation and a second hardware representation of a second packet flow table into one or more second groups based on second dimensions of at least the first hardware representation and the second hardware representation, and generate the second candidate configurations of the two or more CAM slices based on the one or more first groups and the one or more second groups.

Example 4 includes the apparatus of any of examples 2 or 3, wherein the parameters are first parameters, the packet flow table is a first packet flow table, the hardware representation is a first hardware representation, the first parameters include a packet type to be detected by the first packet flow table and a first priority of the first packet flow table, and one or more of the at least one programmable circuit is to based on a second packet flow table sharing the packet type with the first packet flow table and having a second priority different than the first priority, combine the first hardware representation of the first packet flow table and a second hardware representation of the second packet flow table into a composite hardware representation, and generate the second candidate configurations based on the composite hardware representation.

Example 5 includes the apparatus of any of examples 1, 2, 3, or 4, wherein one or more of the at least one programmable circuit is to determine scores for the candidate configurations, respective scores based on at least one of power consumption by, rule capacity of, or network performance for respective configurations, determine weighted scores for the candidate configurations based on the scores and at least one user preference, and select the one of the candidate configurations based on the weighted scores.

Example 6 includes the apparatus of any of examples 1, 2, 3, 4, or 5, wherein the packet flow table is a first packet flow table, the parameters are first parameters, the hardware representation is a first hardware representation, the interface circuitry is to access the first parameters as code and second parameters for a second packet flow table as a natural language input, and one or more of the at least one programmable circuit is to compile the code to generate the first hardware representation of the first packet flow table, and process, with a machine learning model, the natural language input to generate a second hardware representation of the second packet flow table.

Example 7 includes the apparatus of any of examples 1, 2, 3, 4, 5, or 6, wherein the parameters for the packet flow table includes a packet type to be detected by the packet flow table, a key field against which to classify packets detected by the packet flow table, a priority of the packet flow table, and a threshold for a rule count of the packet flow table.

Example 8 includes at least one non-transitory computer-readable medium comprising instructions to cause at least one programmable circuit to based on parameters to be used to configure content-addressable memory (CAM) of a compute device to implement a packet flow table, convert the parameters into a hardware representation of the packet flow table, generate, based on the hardware representation, candidate configurations of two or more CAM slices of the compute device that satisfy the parameters, select one of the candidate configurations of the two or more CAM slices to implement the packet flow table based on respective performance characteristics of the candidate configurations, and configure the two or more CAM slices based on the selected one of the candidate configurations.

Example 9 includes the at least one non-transitory computer-readable medium of example 8, wherein the candidate configurations are first candidate configurations, and the instructions cause one or more of the at least one programmable circuit to generate second candidate configurations of the two or more CAM slices based on the hardware representation, generate mappings of the hardware representation to each of the second candidate configurations of the two or more CAM slices, verify which of the mappings satisfy the parameters for the packet flow table, and generate the first candidate configurations of the two or more CAM slices as a subset of the second candidate configurations that correspond to the mappings that satisfy the parameters of the packet flow table.

Example 10 includes the at least one non-transitory computer-readable medium of example 9, wherein the packet flow table is a first packet flow table, the hardware representation is a first hardware representation, and the instructions cause one or more of the at least one programmable circuit to categorize the two or more CAM slices of the compute device into one or more first groups based on first dimensions of the two or more CAM slices, categorize at least the first hardware representation and a second hardware representation of a second packet flow table into one or more second groups based on second dimensions of at least the first hardware representation and the second hardware representation, and generate the second candidate configurations of the two or more CAM slices based on the one or more first groups and the one or more second groups.

Example 11 includes the at least one non-transitory computer-readable medium of any of examples 9 or 10, wherein the parameters are first parameters, the packet flow table is a first packet flow table, the hardware representation is a first hardware representation, the first parameters include a packet type to be detected by the first packet flow table and a first priority of the first packet flow table, and the instructions cause one or more of the at least one programmable circuit to based on a second packet flow table sharing the packet type with the first packet flow table and having a second priority different than the first priority, combine the first hardware representation of the first packet flow table and a second hardware representation of the second packet flow table into a composite hardware representation, and generate the second candidate configurations based on the composite hardware representation.

Example 12 includes the at least one non-transitory computer-readable medium of any of examples 8, 9, 10, or 11, wherein the instructions cause one or more of the at least one programmable circuit to determine scores for the candidate configurations, respective scores based on at least one of power consumption by, rule capacity of, or network performance for respective configurations, determine weighted scores for the candidate configurations based on the scores and at least one user preference, and select the one of the candidate configurations based on the weighted scores.

Example 13 includes the at least one non-transitory computer-readable medium of any of examples 8, 9, 10, 11, or 12, wherein the packet flow table is a first packet flow table, the parameters are first parameters, the hardware representation is a first hardware representation, and the instructions cause one or more of the at least one programmable circuit to based on code representative of the first parameters, compile the code to generate the first hardware representation of the first packet flow table, and process, with a machine learning model, a natural language representation of second parameters to generate a second hardware representation of a second packet flow table, the second parameters for the second packet flow table.

Example 14 includes the at least one non-transitory computer-readable medium of any of examples 8, 9, 10, 11, 12, or 13, wherein the parameters for the packet flow table includes a packet type to be detected by the packet flow table, a key field against which to classify packets detected by the packet flow table, a priority of the packet flow table, and a threshold for a rule count of the packet flow table.

Example 15 includes a method comprising accessing parameters to be used to configure content-addressable memory (CAM) of a compute device to implement a packet flow table, converting, by executing at least one instruction with at least one programmable circuit, the parameters into a hardware representation of the packet flow table, generating, based on the hardware representation, candidate configurations of two or more CAM slices of the compute device that satisfy the parameters, selecting, by executing at least one instruction with one or more of the at least one programmable circuit, one of the candidate configurations of the two or more CAM slices to implement the packet flow table based on respective performance characteristics of the candidate configurations, and configuring, by executing at least one instruction with one or more of the at least one programmable circuit, the two or more CAM slices based on the selected one of the candidate configurations.

Example 16 includes the method of example 15, wherein the candidate configurations are first candidate configurations, and the method includes generating second candidate configurations of the two or more CAM slices based on the hardware representation, generating mappings of the hardware representation to each of the second candidate configurations of the two or more CAM slices, verifying which of the mappings satisfy the parameters for the packet flow table, and generating the first candidate configurations of the two or more CAM slices as a subset of the second candidate configurations that correspond to the mappings that satisfy the parameters of the packet flow table.

Example 17 includes the method of example 16, wherein the packet flow table is a first packet flow table, the hardware representation is a first hardware representation, and the method includes categorizing the two or more CAM slices of the compute device into one or more first groups based on first dimensions of the two or more CAM slices, categorizing at least the first hardware representation and a second hardware representation of a second packet flow table into one or more second groups based on second dimensions of at least the first hardware representation and the second hardware representation, and generating the second candidate configurations of the two or more CAM slices based on the one or more first groups and the one or more second groups.

Example 18 includes the method of any of examples 16 or 17, wherein the parameters are first parameters, the packet flow table is a first packet flow table, the hardware representation is a first hardware representation, the first parameters include a packet type to be detected by the first packet flow table and a first priority of the first packet flow table, and the method includes based on a second packet flow table sharing the packet type with the first packet flow table and having a second priority different than the first priority, combining the first hardware representation of the first packet flow table and a second hardware representation of the second packet flow table into a composite hardware representation, and generating the second candidate configurations based on the composite hardware representation.

Example 19 includes the method of any of examples 15, 16, 17, or 18, including determining scores for the candidate configurations, respective scores based on at least one of power consumption by, rule capacity of, or network performance for respective configurations, determining weighted scores for the candidate configurations based on the scores and at least one user preference, and selecting the one of the candidate configurations based on the weighted scores.

Example 20 includes the method of any of examples 15, 16, 17, 18, or 19, wherein the packet flow table is a first packet flow table, the parameters are first parameters, the hardware representation is a first hardware representation, and the method includes accessing the first parameters as code and second parameters for a second packet flow table as a natural language input, compiling the code to generate the first hardware representation of the first packet flow table, and processing, with a machine learning model, the natural language input to generate a second hardware representation of the second packet flow table.

Example 21 includes the method of any of examples 15, 16, 17, 18, 19, or 20, wherein the parameters for the packet flow table includes a packet type to be detected by the packet flow table, a key field against which to classify packets detected by the packet flow table, a priority of the packet flow table, and a threshold for a rule count of the packet flow table.

Example 22 includes an apparatus comprising means for accessing parameters to be used to configure content-addressable memory (CAM) of a compute device to implement a packet flow table, means for converting the parameters into a hardware representation of the packet flow table, means for generating, based on the hardware representation, candidate configurations of two or more CAM slices of the compute device that satisfy the parameters, means for selecting one of the candidate configurations of the two or more CAM slices to implement the packet flow table based on respective performance characteristics of the candidate configurations, and means for configuring the two or more CAM slices based on the selected one of the candidate configurations.

Example 23 includes the apparatus of example 22, wherein the candidate configurations are first candidate configurations, and the means for generating is to generate second candidate configurations of the two or more CAM slices based on the hardware representation, generate mappings of the hardware representation to each of the second candidate configurations of the two or more CAM slices, verify which of the mappings satisfy the parameters for the packet flow table, and generate the first candidate configurations of the two or more CAM slices as a subset of the second candidate configurations that correspond to the mappings that satisfy the parameters of the packet flow table.

Example 24 includes the apparatus of example 23, wherein the packet flow table is a first packet flow table, the hardware representation is a first hardware representation, and the means for generating is to categorize the two or more CAM slices of the compute device into one or more first groups based on first dimensions of the two or more CAM slices, categorize at least the first hardware representation and a second hardware representation of a second packet flow table into one or more second groups based on second dimensions of at least the first hardware representation and the second hardware representation, and generate the second candidate configurations of the two or more CAM slices based on the one or more first groups and the one or more second groups.

Example 25 includes the apparatus of any of examples 23 or 24, wherein the parameters are first parameters, the packet flow table is a first packet flow table, the hardware representation is a first hardware representation, the first parameters include a packet type to be detected by the first packet flow table and a first priority of the first packet flow table, and the means for generating is to based on a second packet flow table sharing the packet type with the first packet flow table and having a second priority different than the first priority, combine the first hardware representation of the first packet flow table and a second hardware representation of the second packet flow table into a composite hardware representation, and generate the second candidate configurations based on the composite hardware representation.

Example 26 includes the apparatus of any of examples 22, 23, 24, or 25, wherein the means for selecting is to determine scores for the candidate configurations, respective scores based on at least one of power consumption by, rule capacity of, or network performance for respective configurations, determine weighted scores for the candidate configurations based on the scores and at least one user preference, and select the one of the candidate configurations based on the weighted scores.

Example 27 includes the apparatus of any of examples 22, 23, 24, 25, or 26, wherein the packet flow table is a first packet flow table, the parameters are first parameters, the hardware representation is a first hardware representation, and the means for accessing is to access the first parameters as code and second parameters for a second packet flow table as a natural language input, and the means for converting is to compile the code to generate the first hardware representation of the first packet flow table, and process, with a machine learning model, the natural language input to generate a second hardware representation of the second packet flow table.

Example 28 includes the apparatus of any of examples 22, 23, 24, 25, 26, or 27, wherein the parameters for the packet flow table includes a packet type to be detected by the packet flow table, a key field against which to classify packets detected by the packet flow table, a priority of the packet flow table, and a threshold for a rule count of the packet flow table.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry to access parameters to be used to configure content-addressable memory (CAM) of a compute device to implement a packet flow table;
machine-readable instructions; and
at least one programmable circuit to be programmed by the machine-readable instructions to:
convert the parameters into a hardware representation of the packet flow table;
generate, based on the hardware representation, candidate configurations of two or more CAM slices of the compute device that satisfy the parameters;
select one of the candidate configurations of the two or more CAM slices to implement the packet flow table based on respective performance characteristics of the candidate configurations; and
configure the two or more CAM slices based on the selected one of the candidate configurations.

2. The apparatus of claim 1, wherein the candidate configurations are first candidate configurations, and one or more of the at least one programmable circuit is to:
generate second candidate configurations of the two or more CAM slices based on the hardware representation;
generate mappings of the hardware representation to each of the second candidate configurations of the two or more CAM slices;
verify which of the mappings satisfy the parameters for the packet flow table; and
generate the first candidate configurations of the two or more CAM slices as a subset of the second candidate configurations that correspond to the mappings that satisfy the parameters of the packet flow table.

3. The apparatus of claim 2, wherein the packet flow table is a first packet flow table, the hardware representation is a first hardware representation, and one or more of the at least one programmable circuit is to:
categorize the two or more CAM slices of the compute device into one or more first groups based on first dimensions of the two or more CAM slices;
categorize at least the first hardware representation and a second hardware representation of a second packet flow table into one or more second groups based on second dimensions of at least the first hardware representation and the second hardware representation; and
generate the second candidate configurations of the two or more CAM slices based on the one or more first groups and the one or more second groups.

4. The apparatus of claim 2, wherein the parameters are first parameters, the packet flow table is a first packet flow table, the hardware representation is a first hardware representation, the first parameters include a packet type to be detected by the first packet flow table and a first priority of the first packet flow table, and one or more of the at least one programmable circuit is to:
based on a second packet flow table sharing the packet type with the first packet flow table and having a second priority different than the first priority, combine the first hardware representation of the first packet flow table and a second hardware representation of the second packet flow table into a composite hardware representation; and
generate the second candidate configurations based on the composite hardware representation.

5. The apparatus of claim 1, wherein one or more of the at least one programmable circuit is to:
determine scores for the candidate configurations, respective scores based on at least one of power consumption by, rule capacity of, or network performance for respective configurations;
determine weighted scores for the candidate configurations based on the scores and at least one user preference; and
select the one of the candidate configurations based on the weighted scores.

6. The apparatus of claim 1, wherein the packet flow table is a first packet flow table, the parameters are first parameters, the hardware representation is a first hardware representation, the interface circuitry is to access the first parameters as code and second parameters for a second packet flow table as a natural language input, and one or more of the at least one programmable circuit is to:
compile the code to generate the first hardware representation of the first packet flow table; and
process, with a machine learning model, the natural language input to generate a second hardware representation of the second packet flow table.

7. The apparatus of claim 1, wherein the parameters for the packet flow table includes:
a packet type to be detected by the packet flow table;
a key field against which to classify packets detected by the packet flow table;
a priority of the packet flow table; and
a threshold for a rule count of the packet flow table.

8. At least one non-transitory computer-readable medium comprising instructions to cause at least one programmable circuit to:
based on parameters to be used to configure content-addressable memory (CAM) of a compute device to implement a packet flow table, convert the parameters into a hardware representation of the packet flow table;
generate, based on the hardware representation, candidate configurations of two or more CAM slices of the compute device that satisfy the parameters;
select one of the candidate configurations of the two or more CAM slices to implement the packet flow table based on respective performance characteristics of the candidate configurations; and
configure the two or more CAM slices based on the selected one of the candidate configurations.

9. The at least one non-transitory computer-readable medium of claim 8, wherein the candidate configurations are first candidate configurations, and the instructions cause one or more of the at least one programmable circuit to:
generate second candidate configurations of the two or more CAM slices based on the hardware representation;
generate mappings of the hardware representation to each of the second candidate configurations of the two or more CAM slices;
verify which of the mappings satisfy the parameters for the packet flow table; and
generate the first candidate configurations of the two or more CAM slices as a subset of the second candidate configurations that correspond to the mappings that satisfy the parameters of the packet flow table.

10. The at least one non-transitory computer-readable medium of claim 9, wherein the packet flow table is a first packet flow table, the hardware representation is a first hardware representation, and the instructions cause one or more of the at least one programmable circuit to:
categorize the two or more CAM slices of the compute device into one or more first groups based on first dimensions of the two or more CAM slices;
categorize at least the first hardware representation and a second hardware representation of a second packet flow table into one or more second groups based on second dimensions of at least the first hardware representation and the second hardware representation; and
generate the second candidate configurations of the two or more CAM slices based on the one or more first groups and the one or more second groups.

11. The at least one non-transitory computer-readable medium of claim 9, wherein the parameters are first parameters, the packet flow table is a first packet flow table, the hardware representation is a first hardware representation, the first parameters include a packet type to be detected by the first packet flow table and a first priority of the first packet flow table, and the instructions cause one or more of the at least one programmable circuit to:
based on a second packet flow table sharing the packet type with the first packet flow table and having a second priority different than the first priority, combine the first hardware representation of the first packet flow table and a second hardware representation of the second packet flow table into a composite hardware representation; and
generate the second candidate configurations based on the composite hardware representation.

12. The at least one non-transitory computer-readable medium of claim 8, wherein the instructions cause one or more of the at least one programmable circuit to:
determine scores for the candidate configurations, respective scores based on at least one of power consumption by, rule capacity of, or network performance for respective configurations;
determine weighted scores for the candidate configurations based on the scores and at least one user preference; and
select the one of the candidate configurations based on the weighted scores.

13. The at least one non-transitory computer-readable medium of claim 8, wherein the packet flow table is a first packet flow table, the parameters are first parameters, the hardware representation is a first hardware representation, and the instructions cause one or more of the at least one programmable circuit to:
based on code representative of the first parameters, compile the code to generate the first hardware representation of the first packet flow table; and
process, with a machine learning model, a natural language representation of second parameters to generate a second hardware representation of a second packet flow table, the second parameters for the second packet flow table.

14. The at least one non-transitory computer-readable medium of claim 8, wherein the parameters for the packet flow table includes:
a packet type to be detected by the packet flow table;
a key field against which to classify packets detected by the packet flow table;
a priority of the packet flow table; and
a threshold for a rule count of the packet flow table.

15. A method comprising:
accessing parameters to be used to configure content-addressable memory (CAM) of a compute device to implement a packet flow table;
converting, by executing at least one instruction with at least one programmable circuit, the parameters into a hardware representation of the packet flow table;
generating, based on the hardware representation, candidate configurations of two or more CAM slices of the compute device that satisfy the parameters;
selecting, by executing at least one instruction with one or more of the at least one programmable circuit, one of the candidate configurations of the two or more CAM slices to implement the packet flow table based on respective performance characteristics of the candidate configurations; and
configuring, by executing at least one instruction with one or more of the at least one programmable circuit, the two or more CAM slices based on the selected one of the candidate configurations.

16. The method of claim 15, wherein the candidate configurations are first candidate configurations, and the method includes:
generating second candidate configurations of the two or more CAM slices based on the hardware representation;
generating mappings of the hardware representation to each of the second candidate configurations of the two or more CAM slices;
verifying which of the mappings satisfy the parameters for the packet flow table; and
generating the first candidate configurations of the two or more CAM slices as a subset of the second candidate configurations that correspond to the mappings that satisfy the parameters of the packet flow table.

17. The method of claim 16, wherein the packet flow table is a first packet flow table, the hardware representation is a first hardware representation, and the method includes:
categorizing the two or more CAM slices of the compute device into one or more first groups based on first dimensions of the two or more CAM slices;
categorizing at least the first hardware representation and a second hardware representation of a second packet flow table into one or more second groups based on second dimensions of at least the first hardware representation and the second hardware representation; and
generating the second candidate configurations of the two or more CAM slices based on the one or more first groups and the one or more second groups.

18. The method of claim 16, wherein the parameters are first parameters, the packet flow table is a first packet flow table, the hardware representation is a first hardware representation, the first parameters include a packet type to be detected by the first packet flow table and a first priority of the first packet flow table, and the method includes:
based on a second packet flow table sharing the packet type with the first packet flow table and having a second priority different than the first priority, combining the first hardware representation of the first packet flow table and a second hardware representation of the second packet flow table into a composite hardware representation; and
generating the second candidate configurations based on the composite hardware representation.

19. The method of claim 15, including:
determining scores for the candidate configurations, respective scores based on at least one of power consumption by, rule capacity of, or network performance for respective configurations;
determining weighted scores for the candidate configurations based on the scores and at least one user preference; and
selecting the one of the candidate configurations based on the weighted scores.

20. The method of claim 15, wherein the packet flow table is a first packet flow table, the parameters are first parameters, the hardware representation is a first hardware representation, and the method includes:
accessing the first parameters as code and second parameters for a second packet flow table as a natural language input;
compiling the code to generate the first hardware representation of the first packet flow table; and
processing, with a machine learning model, the natural language input to generate a second hardware representation of the second packet flow table.

21.-28. (canceled)
